(19) United States
(12) Patent Application Publication
(10) Pub. No.: US 2005/0091231 A1
(43) Pub. Date: Apr. 28, 2005

(54) System and method for storing and retrieving XML data encapsulated as an object in a database store

(76) Inventors: Shankar Pal, Redmond, WA (US); Ramachandran Venkatesh, Bellevue, WA (US); Jose A. Blakeley, Redmond, WA (US); Denis Y. Altudov, Redmond, WA (US); Istvan Cseri, Redmond, WA (US); Chia-Hsun Chen, Redmond, WA (US); Alazel Acheson, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/693,158

(22) Filed: Oct. 24, 2003

(51) Int. Cl. G06F 7/00

(52) U.S. Cl. 707/100

(57) ABSTRACT

A system and method are provided for modeling structured, semi-structured, and unstructured data all within a single instance of a user defined type (UDT) within a database store. In particular, the XML data model is extended to fields of a UDT. As a result, the properties of the XML data model—such as document order and document structure—can be preserved within instances of a UDT. Moreover, code representing object behavior (i.e., methods that can be invoked on an object in managed code) can be added to the UDT to operate on an XML field, as well as non-XML fields of the UDT. This enables a framework for adding business logic to XML data. The content model of the XML data can be optionally described using XML schema documents associated with the XML fields of the UDT.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright @ 2003, Microsoft Corp.

### FIELD OF THE INVENTION

The present invention relates to data storage in a computer system, and more particularly, to a system and method for storing and retrieving XML data in a database store as a field of a user defined type.

### BACKGROUND

Microsoft SQL SERVER is a comprehensive database management platform that provides extensive data management and development tools, a powerful extraction, transformation, and loading (ETL) tool, business intelligence and analysis services, and other capabilities. Two improvements to SQL SERVER have recently been implemented. First, the Microsoft Windows .NET Framework Common Language Runtime (CLR) has been integrated into the SQL SERVER database, and second, a new object, referred to as a User Defined Type (UDT), can now be created with managed code in the CLR environment and persisted in the database store.

The CLR is the heart of the Microsoft .NET Framework, and provides the execution environment for all NET code. Thus, code that runs within the CLR is referred to as “managed code.” The CLR provides various functions and services required for program execution, including just-in-time (JIT) compilation, allocating and managing memory, enforcing type safety, exception handling, thread management and security. The CLR is now loaded by SQL SERVER upon the first invocation of a .NET routine.

In previous versions of SQL SERVER, database programmers were limited to using Transact-SQL when writing code on the server side. Transact-SQL is an extension of the Structured Query Language as defined by the International Standards Organization (ISO) and the American National Standards Institute (ANSI). Using Transact-SQL, database developers can create, modify and delete databases and tables, as well as insert, retrieve, modify and delete data stored in a database. Transact-SQL is specifically designed for direct structural data access and manipulation. While Transact-SQL excels at data access and management, it is not a full-fledged programming language in the way that Visual Basic .NET and C# are. For example, Transact-SQL does not support arrays, collections, for each loops, bit shifting or classes.

With the CLR integrated into the SQL SERVER database, database developers can now perform tasks that were impossible or difficult to achieve with Transact-SQL alone. Both Visual Basic NET and C# are modern programming languages offering full support for arrays, structured exception handling, and collections. Developers can leverage CLR integration to write code that has more complex logic and is more suited for computation tasks using languages such as Visual Basic NET and C#.

In addition to CLR integration, SQL SERVER also adds support for User Defined Types (UDT)—a new mechanism that enables a developer to extend the scalar type system of the database. UDTs provide two key benefits from an application architecture perspective: they provide strong encapsulation (both in the client and the server) between the internal state and the external behaviors, and they provide deep integration with other related server features. Once a UDT is defined, it can be used in all the contexts that a system type can be used in SQL SERVER, including in column definitions, variables, parameters, function results, cursors, triggers, and replication.

The process of defining a UDT on a database server is accomplished as follows:
a) create a class in managed code that follows the rules for UDT creation;
b) load the Assembly that contains the UDT into a database on the server using the CREATE ASSEMBLY statement; and
c) create a type in the database using the CREATE TYPE statement that exposes the managed code UDT.
   At this point, the UDT can be used in a table definition.

When a UDT definition is created in managed code, the type must meet the following requirements:
a) it must be marked as Serializable;
b) it must be decorated with the SqlUserDefinedTypeAttribute;
c) the type should be NULL aware by implementing the INullable interface;
d) the type must have a public constructor that takes no arguments; and
e) the type should support conversion to and from a string by implementing the following methods:
   1. Public String ToString( ); and
   2. Public Shared <type> Parse (SqlString s).

Co-pending, commonly assigned, patent application Ser. No. ______ filed Oct. 23, 2003, entitled “System And Method For Object Persistence In A Database Store” (Attorney Docket: MSFT-2852/306819.1), which is hereby incorporated by reference in its entirety, describes another feature of UDTs in which the fields and behaviors of a CLR class definition for a UDT are annotated with storage attributes that describe a layout structure for instances of the UDT in the database store. Specifically, each field of a CLR class that defines a UDT is annotated with a storage attribute that controls the storage facets of the type, such as size, precision, scale, etc. In one embodiment, this is achieved by annotating each field with a custom storage attribute named SqlUdtFieldo. This attribute annotates fields with additional storage directives. These directives are enforced when the object is serialized to disk. In addition, every managed behavior (e.g., a method that can be invoked on the UDT object, for example, to return the value of a field) defined in the CLR class is annotated with an attribute that denotes an equivalent structural access path for that managed behavior. In one embodiment, the custom attribute used for this purpose is named SqlUdtProperty( ), and the database server (e.g., SQL SERVER) assumes that the implementation of properties annotated with this custom attribute will delegate to a field specified as part of the attribute definition. This lets the server optimize access to the property structurally without creating an instance and invoking the behavior on it.

FIG. 1 is an exemplary code listing of a CLR class that defines a UDT. As shown, the CLR class has been annotated with the SqlUdtField( ) and SqlUdtProperty( ) custom attributes as described above. Specifically, the SqlUdtField( ) custom attribute has been added at lines 5, 8, 37, and 49 to annotate the respective fields of the exemplary UDT class definition. The SqlUdtProperty( ) custom attribute has been added at lines 11 and 24 to annotate the respective managed behaviors of the class.

The CLR class that defines the UDT is then compiled into a dynamic link library (dll). An Assembly containing the compiled class may then be created using the following T-SQL script commands:

create assembly test
from ‘c:\test.dll’
go

The following T-SQL script commands may then be used to create the UDT on the server:

create type BaseItem
external name [test]:[BaseItem]
go

Once the UDT has been created on the server, a table (e.g., “MyTable”) can be created defining an attribute of the table as the UDT type, as follows:

```
create table MyTable
(
    Item BaseItem,
    ItemId as item::ID
)
go
```

A new item can be added to the table, as follows:

declare @i BaseItem
set @i = convert(BaseItem, ”)
insert into MyTable values (@i)
go

The UDT expression can then be used in a query such as: SELECT Item.ID, Item.Name FROM MyTable.

With the integration of the CLR into SQL SERVER and the ability to define UDTs from a class definition in managed code, applications can now instantiate objects of the type defined by the managed code class and have those objects persisted in the relational database store as a UDT. Moreover, the class that defines the UDT can also include methods that implement specific behaviors on objects of that type. An application can therefore instantiate objects of a type defined as a UDT and can invoke managed behaviors over them.

When an object of a class that has been defined as a UDT is instantiated in the CLR, the object can be persisted in the database store through the process of object serialization, wherein the values of the variables of the class are transferred to physical storage (e.g., hard disk). FIG. 2 illustrates the serialization of an object in memory to its persisted form on disk. The object may be persisted in the database store in a traditional relational database table of the format illustrated in FIG. 3. As shown, the table comprises a column of the specified UDT. The serialized values of a persisted object of the specified UDT occupy a cell of the UDT column.

Referring again to FIG. 2, when an application generates a query that includes a predicate or an expression that references a managed behavior of a UDT object that has been persisted in the database store (e.g., a behavior that returns the value of a field of the UDT object), the persisted object must be de-serialized (sometimes also referred to as “hydrating”) and the CLR must allocate memory for the full object in order to receive its stored values. The CLR must then invoke the actual method (i.e., behavior) of the UDT class that returns the value(s) that is the subject of the query. As described in the aforementioned co-pending application Ser. No. ______ (Attorney Docket: MSFT-2852/306819.1), the SqlUdtField( ) and SqlUdtProperty( ) annotations in the CLR class definition of a UDT can be used by the database server to also allow direct structural access to the values of certain UDT fields without the need for object hydration.

The eXtensible Markup Language (XML) is a World Wide Web Consortium (W3C) endorsed standard for document and data representation that provides a generic syntax to mark up data with human-readable tags. XML does not have a fixed set of tags and thus allows users to define such tags as long as they conform to the XML standard. Data may be stored in XML documents as strings of text that are surrounded by text markup. The W3C has codified XML's abstract data model in a specification called the XML information set (XML Infoset). XML Schemas also may be used to apply a structure to the XML format and content. In the case of an XML Schema, a diagram, plan, or framework for XML data in a document may be defined. Although XML is a well-known format that may easily describe the contents of a document, other non-XML formatted data may be desirable in the same database. This produces a potential querying problem because of the inherent incompatibility. An example of such an incompatibility is the presence of XML content in a relational database.

Existing database management systems provide support for storing XML data in a relational database store. For example, Microsoft's SQL SERVER provides support for XML data type columns, variables and parameters. You can create a table with one or more XML columns, store XML values in the XML columns, type an XML column using an XML schema namespace, index the XML column, and query into the XML values. However, while it has been possible in the past to store XML data in a relational data base in these instances, it would be desirable to be able to embed XML data in a field of a user defined type that is created in managed code. The present invention provides this ability.

### SUMMARY

The present invention is directed to a system and method for storing XML data in a field of a user defined type (UDT). One or more fields of a UDT can be defined as an XML data type; the UDT can have other non-XML fields, as well. Data conforming to the XML data model can be stored in the XML fields, while non-XML data is stored in the non-XML fields. Thus, the properties of the XML data model—such as document order and document structure are preserved within instances of a UDT. Moreover, code representing object behavior (i.e., methods that can be invoked on an object in managed code) can be added to the UDT to operate on an XML field, as well as non-XML fields of the UDT. This enables a framework for adding business logic to semi-structured data with XML markup. Additionally, the content model of the XML data can be optionally described using XML schema documents associated with the XML fields of the UDT.

Further according to the invention, to introduce an XML field in a UDT, a common language runtime (CLR) programming model is provided that exposes the XML field as a suitable CLR type. Preferably, this is modeled as a class called SqlXml. For an XML data type field, the SqlXml member allows a new attribute called “XmlSchemaCollection” within the SqlUDTField annotation. The SqlXml class is useful in ADO.NET access to XML data types at the server.

Other features and advantages of the invention may become apparent from the following detailed description of the invention and accompanying drawings.

### BRIEF DESCRIPTION OF THE DRAWINGS

The foregoing summary, as well as the following detailed description of the invention, is better understood when read in conjunction with the appended drawings. For the purpose of illustrating the invention, there is shown in the drawings exemplary embodiments of various aspects of the invention; however, the invention is not limited to the specific methods and instrumentalities disclosed. In the drawings:

FIG. 1 is an exemplary code segment illustrating a managed code class definition for a user defined type;

FIG. 2 is a block diagram illustrating the serialization and deserialization of an instance of a user defined type that has been instantiated in managed code;

FIG. 3 is a diagram illustrating a database table in which an object of a user defined type has been persisted;

FIG. 4 is a table illustrating the members of a SqlXml class, in accordance with one embodiment of the present invention;

FIG. 5 is an exemplary program code listing of a CLR class “Employee” with a SqlXml field, in accordance with an embodiment of the present invention;

FIG. 6 is an exemplary program code listing illustrating how to create a new instance of the Employee class in a NET programming language and to populate it, in accordance with an embodiment of the present invention;

FIG. 7 is an exemplary program code listing illustrating how to obtain an XmlReader from an instance of the Employee class for parsing the XML content, in accordance with an embodiment of the present invention;

FIG. 8 is an exemplary program code listing that illustrates how to update an instance of the Employee class in a NET programming language, in accordance with an embodiment of the present invention;

FIG. 9 is an exemplary program code listing that illustrates the use of an “XmlSchemaCollection” attribute, in accordance with an embodiment of the present invention;

FIG. 10 is an exemplary program code listing illustrating how to obtain validation of XML content at a client, in accordance with an embodiment of the present invention;

FIG. 11 is an exemplary program code listing illustrating how to obtain an XML schema collection name specified in the “XmlSchemaCollection” attribute from a class definition, in accordance with an embodiment of the present invention;

FIG. 12 is an exemplary program code listing illustrating how to retrieve an XML schema collection from a server once the XML schema collection name is known, in accordance with an embodiment of the present invention;

FIG. 13 is an exemplary program code listing that illustrates how to obtain a validating XmlReader, in accordance with an embodiment of the present invention;

FIG. 14 is an exemplary program code listing illustrating how to perform an update with client-side validation, in accordance with an embodiment of the present invention;

FIG. 15 is an exemplary code listing illustrating how a behavior can be added to a CLR class that defines a UDT to implement behavior on an XML data field of the UDT, in accordance with an embodiment of the present invention.

FIG. 16 is a block diagram representing an exemplary network environment having a variety of computing devices in which the present invention may be implemented; and

FIG. 17 is a block diagram representing an exemplary computing device in which the present invention may be implemented.

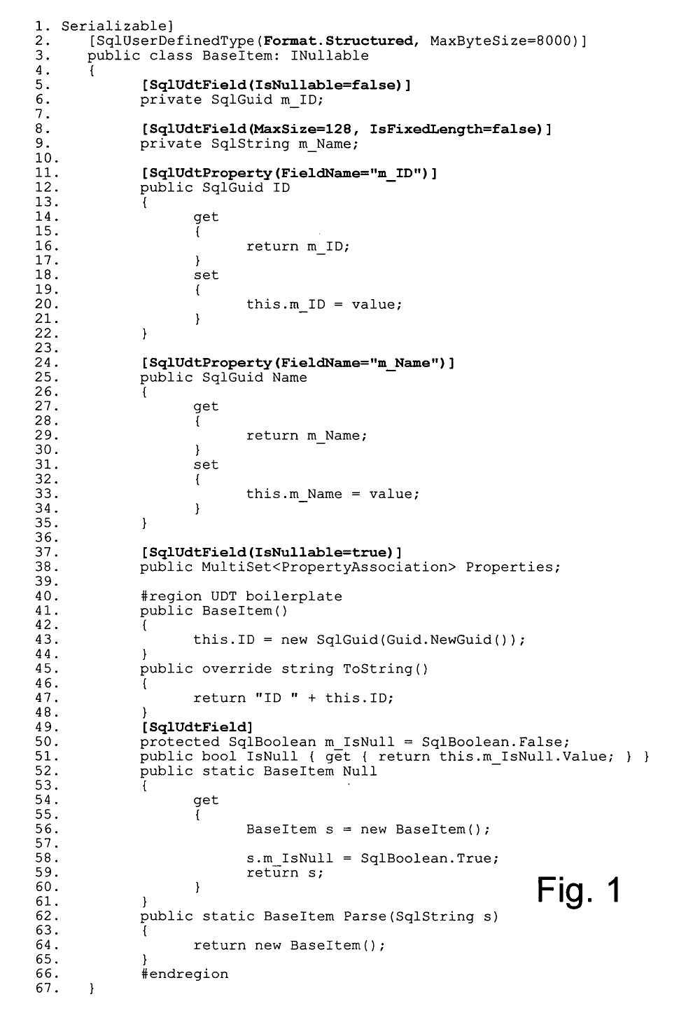

### DETAILED DESCRIPTION OF THE INVENTION

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As stated above, the present invention is directed to a system and method for storing XML data in a field of a user defined type (UDT). A field of a UDT can be defined as an XML data type; the UDT can have other non-XML fields, as well. Data conforming to the XML data model can be stored in the XML fields, while non-XML data is stored in the non-XML fields. Thus, the properties of the XML data model—such as document order and document structure—are preserved within instances of a UDT. Moreover, code representing object behavior (i.e., methods that can be invoked on an object in managed code) can be added to the UDT to operate on an XML field, as well as non-XML fields of the UDT. This enables a framework for adding business logic to semi-structured data. Additionally, the content model of the XML data can be optionally described using XML schema documents associated with the XML fields of the UDT.

Further according to the invention, to introduce an XML field in a UDT, a common language runtime (CLR) programming model is provided that exposes the XML field as a suitable CLR type. Preferably, this is modeled as a class called SqlXml. For an XML data type field, the SqlXml member allows a new attribute called “XmlSchemaCollection” within the SqlUDTField annotation. The SqlXml class is useful in ADO.NET access to XML data types at the server.

The SqlXml Class

According to one aspect of the present invention, a new class is defined to support the storage of XML data in a field of a CLR class. In the present embodiment, this class is called SqlXml, it being understood that the particular name is not critical to the present invention. FIG. 4 is a table that describes the members of the SqlXml class.

As shown in FIG. 4, the SqlXml class supports two constructors. One constructor accepts an XmlReader in its input. XmlReader is a Microsoft .NET Framework abstract class (or interface) that defines fast, non-cached, forward-only read access to XML data. This constructor is useful when a SqlXml object is instantiated from an XmlReader on a stream, another SqlXml instance, or any class from which an XmlReader is available. Since the XML content is read through the XmlReader interface, well-formedness checks occur as part of the constructor. The other constructor accepts a stream as input and is used when well formedness checks are to be skipped in the constructor. Other constructors are also possible.

The CreateReader( ) method returns an XmlReader through which the (XML) content of SqlXml is retrieved. Supporting XmlReader provides a very flexible mechanism on the XML content. For example, an XPathDocument or XPathNavigator can be instantiated on XML data type values from the server.

The SqlXml class is memoryless, and simultaneous CreateReader( ) calls are allowed. Multiple CreateReader( ) invocations return different instances of XmlReader. Each such instance is initialized to the beginning of the XML content encapsulated by the SqlXml object. This allows an instance of SqlXml to be passed to functions and procedures, in which new instances of XML reader can be created.

To update the value of a SqlXml member M, an XmlWriter is used to write into a stream, instantiate an XmlReader on the stream, and instantiate a new SqlXml object M1 from the XmlReader or the stream. An XmlWriter is a .NET Framework abstract class (or interface) that defines a fast, non-cached, forward-only means of generating (writing) streams or files containing XML data that conforms to the W3C Extensible Markup Language (XML) 1.0 and the Namespaces in XML recommendations. XmlTextWritter is a NET Framework class that implements the XmlWriter interface. The following XML string:

```
<root xmlns:x=“urn:1”>
  <x:item/>
  <x:item/>
</x:root>
```

can be generated by the following C# code fragment:

XmlTextWriter w = new XmlTextWriter( );
w.WriteAttributeString(“xmlns”, “x”, null, “urn:1”);
w.WriteStartElement(“item”,“urn:1”);
w.WriteEndElement( );
w.WriteStartElement(“item”,“urn: 1”);
w.WriteEndElement( );
w.WriteEndElement( );

The SqlXml object M1 is then assigned to M. This copies the current state of the source object M1 into M. Other methods on SqlXml are also possible, such as CreateWriter( ) that returns an XmlWriter object, which can be used to update the XML content.

Using SqlXml in a CLR Class

Further according to the present embodiment of the invention, one or more members of a CLR class can be defined as the new SqlXml type. The native CLR type backing SqlXml is one that provides a stream from which XmlReader can be obtained; the stream cannot be accessed directly but only through the XmlReader. It also supports two constructors, one of which accepts an XmlReader and the other a stream.

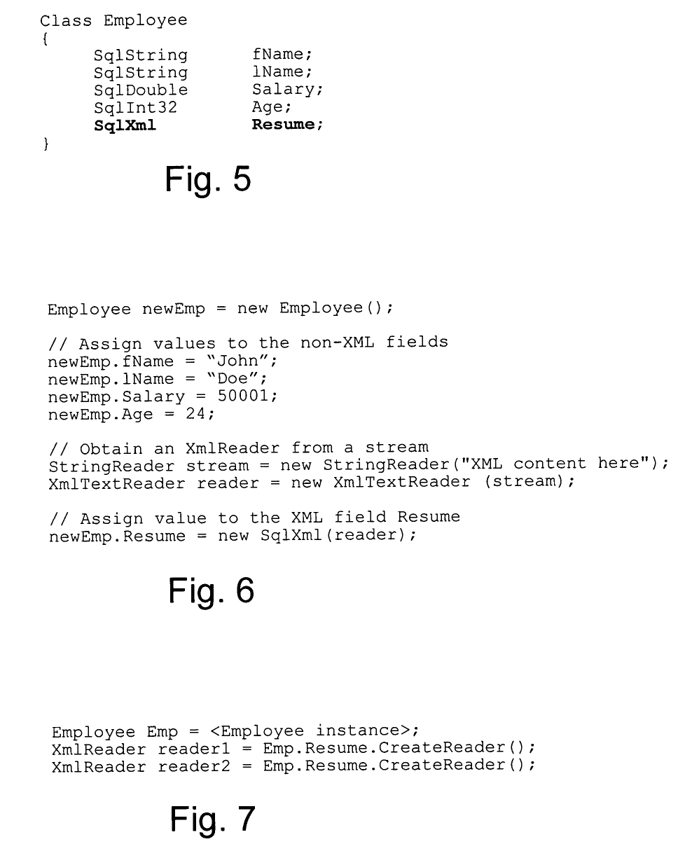

FIG. 5 is an exemplary program code listing of a CLR class “Employee” with a SqlXml field. As shown, the Employee class has several “sqltypes” members that map to primitive SQL types at the server. The Resume member is of type SqlXml. It is backed by the XML data type at the server and by a stream in the CLR. In both cases, the XML content is accessible through XmlReader.

Creating a User-Defined Type with a SqlXml Field

As described above in the Background section, to create a user-define type in SQL from a managed class in a NET programming language, a user first registers the assembly containing the definition of the type using a CREATE ASSEMBLY statement. Then the user-defined type is created using a CREATE TYPE statement as follows:
CREATE TYPE [type-schema-name].udt-name
EXTERNAL NAME assembly-name[:class-name]

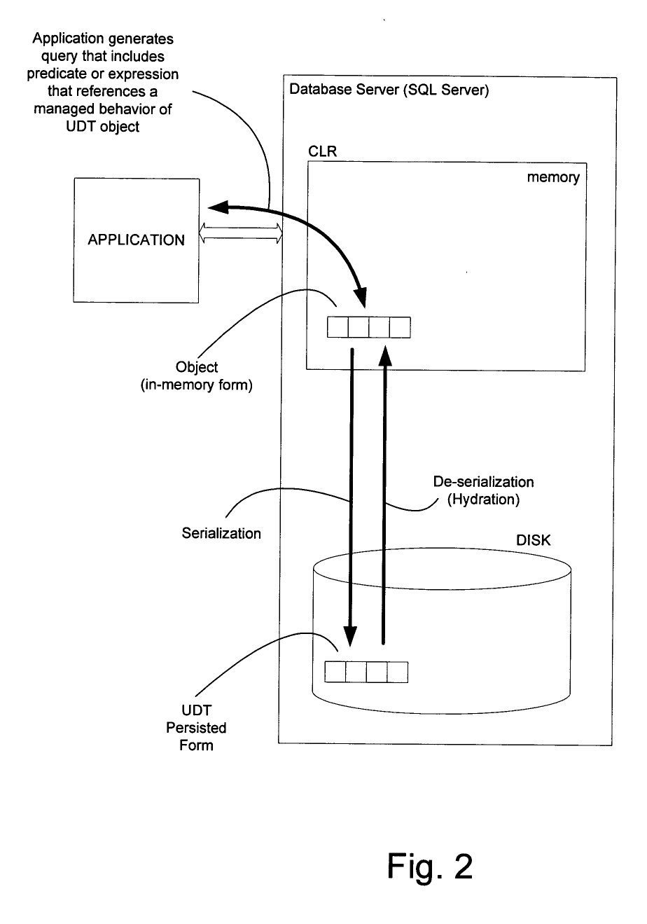

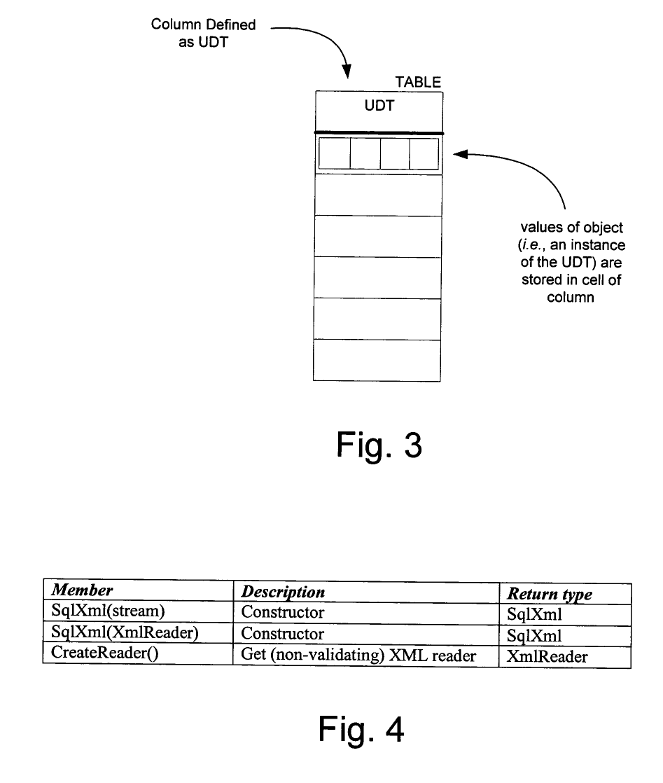

According to the present invention, the SQL user-defined type udt-name may have one or more fields X1, X2, . . . of (untyped) XML data type, corresponding to SqlXml fields M1, M2, . . . in the CLR class C for the UDT. Serialization and deserialization of instances of type udt-name into class C is performed in the usual manner, as described above and illustrated in FIG. 2. All the general rules for creating types hold in this case. The XML fields in udt-name are stored in an internal representation called binary XML as a large binary SQL type.

Once the user-defined type has been created, it can be used as a column type in a table or view, and as SQL variables and parameters, just like any user-defined type without XML fields. As an example, a UDT based on the Employee class defined above, called udtEmp, is created as follows:
CREATE TYPE udtEmp
EXTERNAL NAME myAssembly:Employee
   The udtEmp UDT will have fields of type nvarchar(4000) for fname and lName, float for the Age field, and so on. The SqlXml member Resume of class Employee is mapped to an untyped (i.e., without any XML schema association) XML data type field Resume in udtEmp.

An employee table tabEmployee can be created with an integer column, ID, and an udtEmp column, Employee, as follows:
CREATE TABLE tabEmployee (ID integer, udtEmp EmpCol)
   The table creation sets up schema binding on the user-defined type udtEmp. Rows can be inserted into the table tabEmployee by supplying values for the two columns. XML values inserted into the Resume field of EmpCol are checked for well-formedness at the time of insertion.

At the instance level, an Employee object is serialized into an instance of udtEmp, with the SqlXml member Employee.Resume stored in the field EmpCol.Resume. Conversely, an instance of EmpCol is deserialized into an Employee object, with the value of the EmpCol.Resume field loaded into the Employee.Resume member.

By way of further example, suppose the following T-SQL statement is executed:

| | |
|---|---|
| SELECT | EmpCol.Resume |
| FROM | tabEmployee |

Semantically, each value in column EmpCol (of type udtEmp) is deserialized into an object of type Employee in the CLR. In particular, the XML data type field EmpCol.Resume is loaded into the SqlXml member Employee.Resume, which is returned to the T-SQL layer as XML data type. One optimization is to extract the value of EmpCol.Resume directly and avoid deserialization for extracting the value of the Employee.Resume member.

FIG. 6 is an exemplary program code listing illustrating how to create a new instance of the Employee class in a NET programming language and to populate it. In this example, a new Employee object is created. Its non-XML fields are assigned values in the usual way. For the XML field Resume, an XmlTextReader reader is created on a string value (“XML content here”). Then a new SqlXml object is instantiated on reader and assigned to the Resume field. As mentioned above, an XmlTextReader is a NET Framework class that implements the XmlReader interface.

The XML content is copied using the XmlReader into the internal storage of the Resume field. The retrieval through the reader causes well-formedness checks on the XML content. Any object from which a XmlReader can be obtained will suffice. Thus, you can read from a file or get the XmlReader from some other SqlXml instance.

FIG. 7 is an exemplary program code listing illustrating how to obtain an XmlReader from an instance of the Employee class for parsing the XML content. In that listing, Emp.Resume.CreateReader( ) returns a (non-validating) XmlReader through which XML content can be retrieved. The objects reader1 and reader2 are initialized to the beginning of the XML content. They are independent of one another since SqlXml is memoryless.

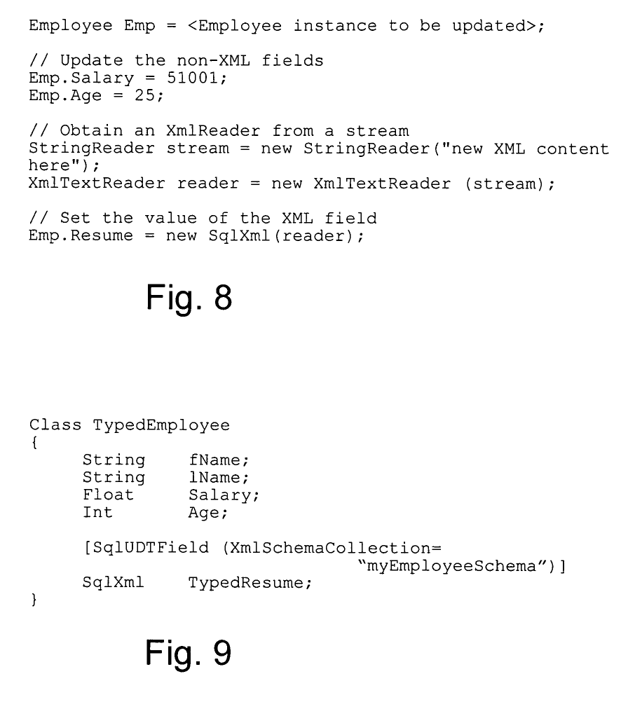

FIG. 8 is an example of a program code listing that illustrates how to update an instance of the Employee class in a NET programming language. The non-XML fields of the Employee object Emp are updated in the usual way. The new XML content (“new XML content here”) is written into a stream, an XmlReader reader is constructed on the stream, and a new SqlXml object is constructed on the reader. The constructed SqlXml object is assigned to the corresponding field Emp.Resume. This causes the XML content to be copied into Emp.Resume. This is an example of a “blind” write. For incremental update, an application can obtain an XML reader from Emp.Resume, read from it, and write the updated content into an XML writer. The update content is based on the current content of Emp.Resume and modifications to it (e.g. add a new phone number).

Typed XML

According to a further aspect of the present invention, an XML field in a UDT can be bound to an XML schema collection at the server. XML schema collections are a new concept in SQL SERVER that allow data instances associated with different XML Schemas to be stored in the same column of a relational database. In accordance with the present invention, the XML schema collection concept is extended to fields of a UDT that have been defined a SqlXml (i.e., fields defined to contain XML data), as described above.

By way of further background regarding XML schema collections, recall from the Background section that XML is a meta-mark-up language for text documents. Data is included in XML documents as strings of text, and the data is surrounded by text markup that describes the data. A particular unit of data and markup is called an element. The XML specification defines the exact syntax this markup must follow: how elements are delimited by tags, what a tag looks like, what names are acceptable for elements, where attributes are placed, and so forth.

XML is flexible in the elements it allows to be defined, but it is strict in many other respects. It provides a grammar for XML documents that regulates placement of tags, where tags appear, which element names are legal, how attributes are attached to elements, and so forth. This grammar is specific enough to allow development of XML parsers that can read and understand any XML document. Documents that satisfy this grammar are said to be well-formed.

To enhance interoperability, individuals or organizations may agree to use only certain tags. These tag sets are called XML applications. An XML application is not a software application like MICROSOFT WORD or MICROSOFT EXCEL. It is a tag set that provides for enhanced functionality of XML for a specific purpose, such as vector graphics, financial data, cooking recipes, or publishing.

An XML schema is a type of XML application, namely one that can describe the allowed content of documents conforming to a particular XML vocabulary. For example, consider the case of a book publisher. The publisher may use an XML application for its business, so that when it provides data (about books, sales, customers, etc.) to other publishers, authors, and customers, they benefit from the increased functionality provided by the XML application, which may be standard in the industry. In addition, the publisher may adopt an XML schema for books, so that every time its computers (and those of his cohorts) access information on books, they access the same information. The information is configured and constrained by the XML schema such that it is uniform for all books.

As further mentioned in the Background, relational databases, such as SQL SERVER, currently provide the ability to store XML data in a relational table like any other data. For example, a table can be created with one or more XML columns, XML values can be stored in those columns, the XML columns can be indexed, and the XML values in those columns can be queried. In addition, an XML column can be “typed” using an XML schema to conform XML data values in that column to the schema. When an XML data value conforming to a given XML schema is found in a relational database, the data is accessed according to the contours of the schema, and as a result, the data can be effectively interpreted.

A problem arises, however, when one attempts to store XML data values conforming to not just one, but several schemas, in the same column of a relational database. One value may be XML data about a book specifying the title of the book, the author of the book, the publishing house, the Copyright year, and so on. Another value may be XML data about a DVD specifying the title of the DVD, the actors and actresses, the director, the genre, the rating, the year released, etc. Assuming it is desirable to store both books and DVDs in a certain columns for data processing efficiencies associated with making determinations for all media, i.e., books and DVDs, at once, the question arises as to which schema should be used to understand and enforce rules on the XML data in the column. Previously, only data conforming to one schema could be stored in a single column. The schema to be used to identify the column would be identified at the top of the column, and any data instance that did not conform to the identified schema would generate an error.

The new concept of XML schema collections solves this problem by allowing XML data associated with multiple, different schemas to be stored in the same column of a relational database via an XML schema collection object. XML schema collections are first class SQL SERVER objects that act as a container for XML schema namespaces. Users can constrain a XML column, parameter and variable using an XML schema collection. This allows them to store instances of XML data conforming to any one of the XML schema namespaces within the constraining XML schema collection.

Thus, an XML schema collection object is a first class SQL object which is a container for XML schema namespaces. In one non-limiting implementation, it is identified by a three part name. The scope of a SQL identifier for XML schema collection is the relational schema within which it is created. Each XML schema collection can contain multiple XML schema namespace universal resource identifiers (URIs). The XML schema namespace is unique within a XML schema collection object, and users can constrain an XML column using an XML schema collection. This allows them to constrain documents against potentially unrelated XML schemas which belong to the XML schema collection.

As mentioned above, in accordance with an aspect of the present invention, the concept of XML schema collections is extended to the fields of a UDT; that is an XML field in a UDT can be bound to an XML schema collection at the server. Binding an XML field in a UDT to an XML schema collection at the server means that each instance of the XML field is valid according to one of the XML schemas in the schema collection. Furthermore, storage is optimized based on the XML schemas, while queries using XML data type methods are optimized using XML schemas for type inference.

The following are the requirements of supporting typed XML in .NET languages. First, the XML schemas typing a class member can be specified at class definition time and not at runtime. That is, the definition should be declarative. Second, the XML schema set associated with an XML reader must be a dynamic set. That is, a schema in the set may be modified (e.g. a new element is added, which corresponds to the creation of a custom property in Windows shell). Deleting an element from a schema should be allowed. Also, a new XML schema may be added to the schema set (e.g. a newly installed application such as PowerPoint adds it own schema to the schema set). Additionally, a schema may be removed from a schema set (e.g. PowerPoint is uninstalled, causing its schema to be dropped from the XML schema collection). A schema may also be replaced with a new version.

To support the binding of an XML field in a UDT to an XML schema collection at the server, in the present embodiment of the invention, a new attribute called “XmlSchemaCollection”, whose value is a string, can be specified on a SqlXml member using the SqlUDTField annotation discussed in the Background section. The value of this attribute denotes the name of an XML schema collection at the server that types the corresponding XML field in the UDT. This is a 1-part name (as opposed to a multipart name), which gives the flexibility of using the class definition with any database and any relational schema. In native CLR context, the SqlUDT annotation on the SqlXml member is ignored. Alternatively, it can be a 3-part name specifying a database, relational schema, and an XML schema collection name.

In the present embodiment, “XmlSchemaCollection” is the only attribute allowed on a SqlXml member; other attributes, if specified, result in the usual error that the attribute is disallowed. Other attributes can be allowed within this document. The syntax of a SqlXml member M specifying the “XmlSchemaCollection” attribute is as follows:

[SqlUDTField (XmlSchemaCollection=“XML-Schema-Collection-
Name”)]
SqlXml M;

The “XmlSchemaCollection” attribute does not cause binding of the SqlXml member M to any XML schema. If an application wants to obtain a validating XmlReader from M, it has the responsibility of associating XML schemas with the validating XmlReader. That is, the SqlXml class continues to provide a non-validating XmlReader on M, and not validating XmlReader, in spite of the presence of the “XmlSchemaCollection” attribute. Alternatively, the attribute can cause XML schema binding and return a validating reader.

An XML schema collection with the name XML-Schema-Collection-Name specified as the value of the “XmlSchemaCollection” attribute must exist in server meta-data. In particular, it must exist in the same relational schema as that in which the UDT udt-name is created. A schema binding is established on “XML-Schema-Collection-Name” from udt-name. If XML-Schema-Collection-Name does not exist, then the CREATE TYPE statement fails to create the user-defined type udt-name.

In the present embodiment, two SqlXml members with the same value for the “XmlSchemaCollection” attribute will share the XML schema collection at the server. This allows applications to optimize storage. The design is more general, allowing an XML schema collection to be shared across multiple members of multiple classes in multiple assemblies.

An instance of CLR class is serialized in the usual way for all class members, including the SqlXml members with “XmlSchemaCollection” attribute specification. These SqlXml members are stored in typed XML fields of the UDT instance; validation against the XML schema collection occurs during insertion and data modification.

For UDT serialization, only the XML content of each SqlXml member is serialized; the XML schemas in the XmlSchemaSet are not. XML schemas must be separately added to or removed from the XML schema collection at the server.

During deserialization, fields of the UDT are loaded into the corresponding members of the CLR class. For a typed XML field, the instance data is exposed as SqlXml objects. The associated XML schema collection is not used. Users can load the XML schema collection into an XmlSchemaSet object in the client, as discussed below.

FIG. 9 is an example of a program code listing that illustrates the use of the “XmlSchemaCollection” attribute. The definition in FIG. 9 assumes that it is desired to type the XML field “Resume” in a user-defined type udtTypedEmp. The SqlUDTField annotation specifies the XML schema collection name “myEmployeeSchema” at the server that types the XML field corresponding to TypedEmployee.TypedResume in the UDT.

The following sequence of operations is used to create a UDT with the typed XML field:
(1) Create the XML schema collection:
   CREATE XML SCHEMA COLLECTION myEmployeeSchema AS ‘<xs:schema xmlns=“book”>...</xs:schema>’
(2) Create the CLR class TypedEmployee
(3) Create the assembly
(4) Create the user-defined type udtTypedEmployee
   The XML schema collection myEmployeeSchema must exist at the server when the user-defined type udtTypedEmployee is created; otherwise, creation of the user-defined type fails.

XML Schema Validation

In the present embodiment, XML Schema Document (XSD) validation can occur at the client when the XML content is retrieved through a validating XmlReader or XML content is written using a validating XmlWriter. At the server, in the present embodiment, XSD validation occurs when an UDT instance is inserted into a column or updated. Thus, in this embodiment, no XSD validation occurs when a new SqlXml object is constructed over a non-validating XmlReader and assigned to a SqlXml member with the “XmlSchemaCollection” attribute specified.

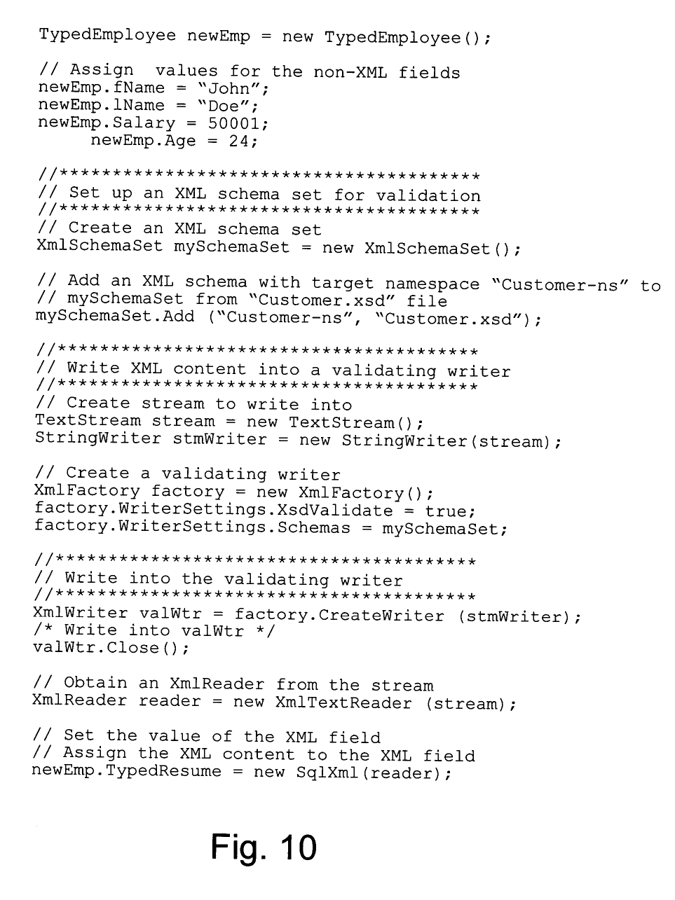

By way of further example, a developer or other user may want to create a new instance of a TypedEmployee class without client-side validation. In such a case, the program code is exactly the same as that for a SqlXml member without SqlUdt annotation (see FIG. 6). However, if validation of the XML content at the client is desired, it can be achieved in the manner illustrated in the exemplary program code listing in FIG. 10. This case differs from the case without client-side validation in that an XmlSchemaSet mySchemaSet is created and populated, and is used to create a validating XmlWriter valWtr over a stream. The XML content written through the valWtr is validated according to mySchemaSet. A non-validating XmlReader reader, obtained from the stream, is used to construct a new instance of SqlXml for assignment to newEmp.TypedResume. It should be appreciated that there are other ways of writing the code. For example, a validating reader can be used instead of the validating writer for client side validation.

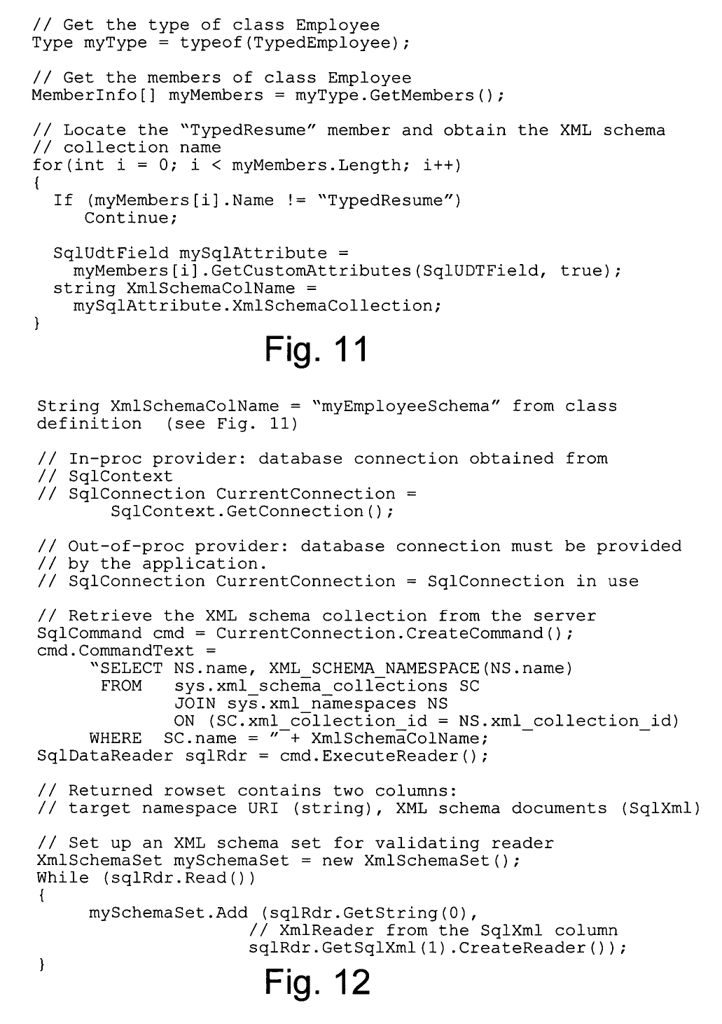

According to another aspect of XML Schema validation, in the present embodiment, it is possible to obtain the XML schema collection name specified in the “XmlSchemaCollection” attribute from a class definition. The exemplary program code listing of FIG. 11 illustrates how this can be done. As shown, there is nothing XML-specific except for the “XmlSchemaCollection” attribute.

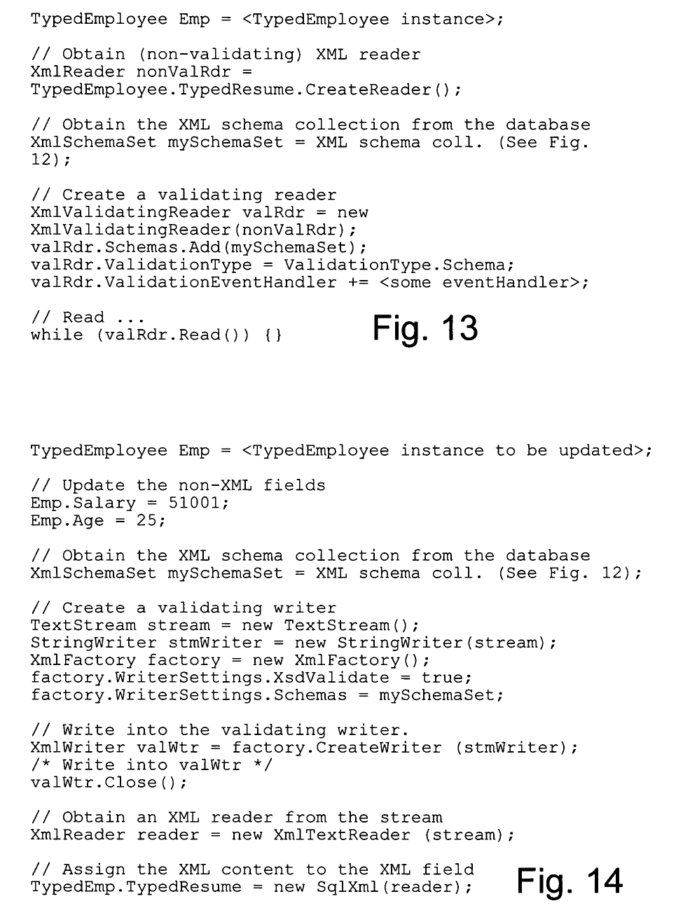

Once the XML schema collection name is known from a class definition as illustrated in FIG. 11, the XML schema collection can be retrieved from the server to populate an XmlSchemaSet object. This object is used in creating a validating XmlReader or XmlWriter. The exemplary program code listing of FIG. 12 illustrates this mechanism.

A database connection is required to retrieve the XML schema collection from the server. For an in-process provider, it is obtained from a SqlContext object. For out-of-process providers, the application supplies the connection (which can be different from the one the data is retrieved through). The SQL statement is executed on the catalog views using the specified XML schema collection name as a parameter. The intrinsic function XML_SCHEMA_COLLECTION( ) is used to retrieve schema documents in a XML data type column, which is deserialized into the SqlXml class. Each schema document is added to the XmlSchemaSet object via XmlReader obtained from the SqlXml object.

To obtain a non-validating reader from the SqlXml member TypedEmployee.TypedResume, the program code is the same as for a SqlXml member without the SqlUdt annotation (see FIG. 7). FIG. 13 is an exemplary program code listing that illustrates how to obtain a validating XmlReader. In this example, the validating XmlReader valRdr is created over a non-validating reader nonValRdr obtained from the SqlXml member TypedEmployee.TypedResume. Before anything is read from valRdr, the XmlSchemaSet object mySchemaSet is added. The validation type is specified to be XSD. Validated content can now be read through the validating reader.

When updating an existing XML value, in the present embodiment, a Sqlxml member can be updated without client-side validation using the same code as that for a SqlXml member without SqlUdt annotation (see FIG. 8). The exemplary program code listing of FIG. 14 illustrates how to perform an update with client-side validation. The XML schema collection is retrieved from the server into an XmlSchemaSet object mySchemaSet. This is used to create a validating XmlWriter valWtr on a stream. The XML content is written into valWtr, a non-validating XmlReader reader is obtained from the stream, and TypedEmp.TypedResume is assigned a new SqlXml object, constructed from the reader.

Manipulation of XML Field in UDT

Further according to the present invention, it is possible to query into and update an XML field of a UDT. For example, it is possible to query into the XML field Resume in the employee table tabEmployee (see example above) as follows:

| | |
|---|---|
| SELECT | EmpCol.Resume.query(‘//Education’) |
| FROM | tabEmployee |
| WHERE | EmpCol.AnnualSalary( ) >40000 |
| AND | EmpCol.fName = ‘John’ |
| AND | EmpCol.Resume.value(‘//Address/ZipCode’, ‘int’) = 98052 |

The expression EmpCol.Resume leads to an XML data type field in the UDT, so the “query” and “value” functions on XML data type can be used to drill down into the XML instance. The non-XML fields are accessed in the usual way. This query also shows an invocation of a function AnnualSalary( ) on the user-defined type udtEmp.

As an example of an update, suppose the zip code of an employee whose first name is “John” changes to 98052. This update can be achieved using the following statement:

| | |
|---|---|
| UPDATE | tabEmployee |
| SET | EmpCol.Resume.modify (‘Update //ZipCode to 98052’) |
| WHERE | EmpCol.fname = ‘John’ |

As the foregoing illustrates, the present invention provides a framework and methodology for modeling structured, semi-structured, and unstructured data all within a single instance of a user defined type (UDT). In particular, the present invention extends the XML data model to fields of a UDT. Thus, the properties of the XML data model—such as document order and document structure—can be preserved within instances of a UDT. As further described above, the content model of the XML data can be optionally described using XML schema documents associated with the XML fields of the UDT.

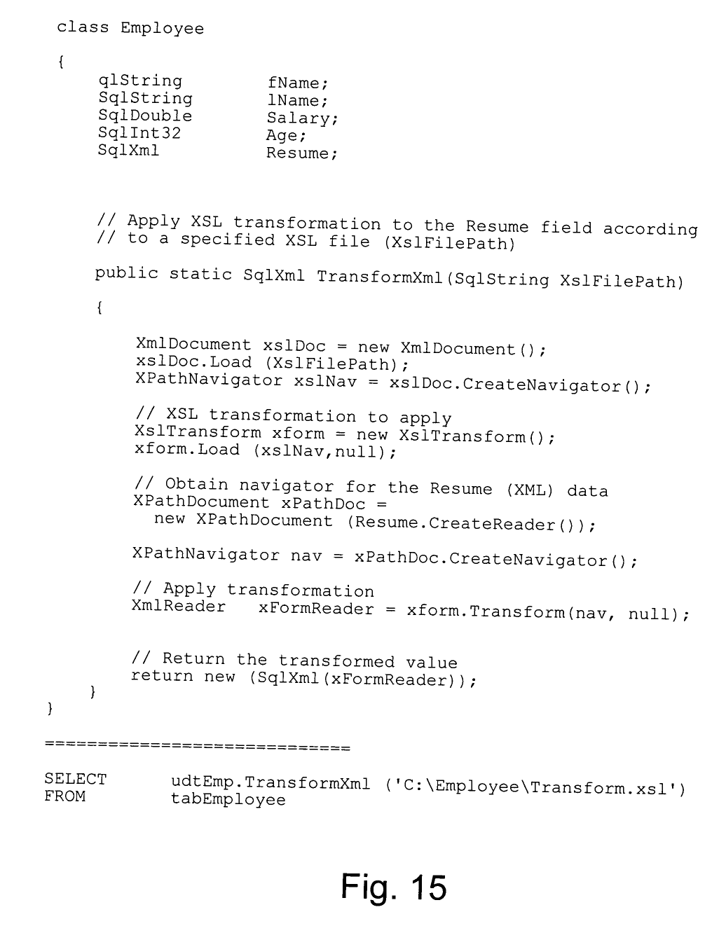

Moreover, because a UDT is defined by a class in managed code, code representing object behavior (i.e., methods that can be invoked on an object in managed code) can be added to the UDT to operate on an XML field, as well as non-XML fields of the UDT. This enables a framework for adding business logic to XML data. FIG. 15 is an exemplary code listing illustrating how a behavior can be added to a CLR class that defines a UDT to implement behavior on a field that is defined as type SqlXml. In this example, a behavior is added that transforms the Resume (XML) data according to a specified eXstensible Stylesheet Language (XSL) file. As shown, the behavior is implemented by the method TransformXml( ) that has been added to the class Employee. The transformed values are returned as the XML data type SqlXml. As shown by the SQL statements at the bottom of the Figure, this method can be invoked on an instance of a UDT generated from the Employee class. Thus, as demonstrated in this example, it is possible to implement behavior on the fields of a UDT that contain XML data. The behaviors that can be implemented are virtually limitless, providing a powerful tool for adding business logic to XML data.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

The present invention may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a computer, the machine becomes an apparatus for practicing the invention.

When implemented on a general-purpose processor, the program code may combine with the processor to provide a unique apparatus that operates analogously to specific logic circuits.

Moreover, the invention can be implemented in connection with any computer or other client or server device, which can be deployed as part of a computer network, or in a distributed computing environment. In this regard, the present invention pertains to any computer system or environment having any number of memory or storage units, and any number of applications and processes occurring across any number of storage units or volumes, which may be used in connection with processes for persisting objects in a database store in accordance with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by exchange between computing devices and systems. These resources and services include, but are not limited to, the exchange of information, cache storage, and disk storage for files. Distributed computing takes advantage of network connectivity, allowing clients to leverage their collective power to benefit the entire enterprise. In this regard, a variety of devices may have applications, objects or resources that may implicate processing performed in connection with the object persistence methods of the present invention.

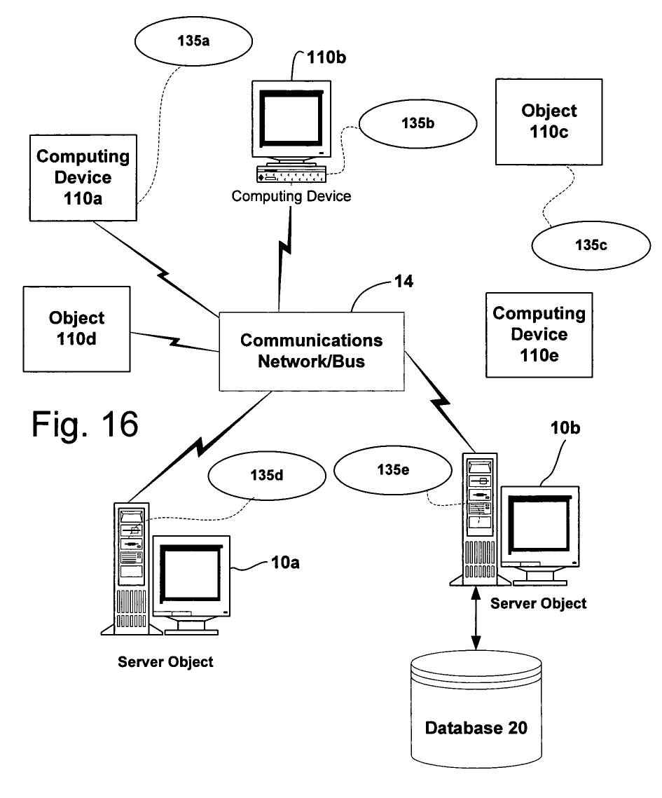

FIG. 16 provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, personal computers, etc. Each object can communicate with another object by way of the communications network 14. This network may itself comprise other computing objects and computing devices that provide services to the system of FIG. 16, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the processes used to implement the object persistence methods of the present invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks. Any of the infrastructures may be used for exemplary communications made incident to the present invention.

The Internet commonly refers to the collection of networks and gateways that utilize the TCP/IP suite of protocols, which are well-known in the art of computer networking. TCP/IP is an acronym for “Transmission Control Protocol/Internet Protocol.” The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 16, computers 110a, 10b, etc. can be thought of as clients and computer 10a, 10b, etc. can be thought of as servers, although any computer could be considered a client, a server, or both, depending on the circumstances. Any of these computing devices may be processing data in a manner that implicates the object persistence techniques of the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the persistence mechanism of the invention may be distributed across multiple computing devices.

Client(s) and server(s) may communicate with one another utilizing the functionality provided by a protocol layer. For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over any available communications medium.

Thus, FIG. 16 illustrates an exemplary networked or distributed environment, with a server in communication with client computers via a network/bus, in which the present invention may be employed. The network/bus 14 may be a LAN, WAN, intranet, the Internet, or some other network medium, with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to maintain a persisted object.

In a network environment in which the communications network/bus 14 is the Internet, for example, the servers 10a, 10b, etc. can be servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment.

Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any computer 10a, 10b, 110a, 110b, etc. may be responsible for the maintenance and updating of a database, memory, or other storage element 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 10a, 110b, etc. and other like devices, and databases 20.

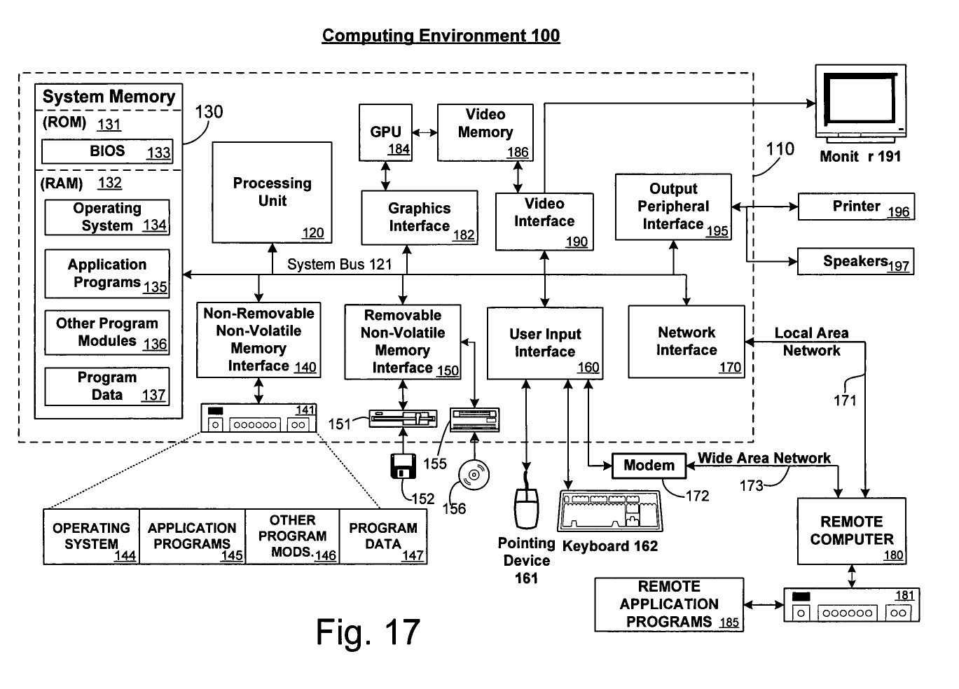

FIG. 17 and the following discussion are intended to provide a brief general description of a suitable computing device in connection with which the invention may be implemented. For example, any of the client and server computers or devices illustrated in FIG. 16 may take this form. It should be understood, however, that handheld, portable and other computing devices and computing objects of all kinds are contemplated for use in connection with the present invention, i.e., anywhere from which data may be generated, processed, received and/or transmitted in a computing environment. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the object persistence methods of the invention.

Although not required, the invention can be implemented via an operating system, for use by a developer of services for a device or object, and/or included within application or server software that operates in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

FIG. 17 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 17, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 17 illustrates operating system 134, application programs 135, other program modules 136, and program data 137.

The computer 110 may also include other removable/non-removable, volatile/nonvolatile computer storage media. By way of example only, FIG. 8 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 17 provide storage of computer readable instructions, data structures, program modules and other data for the computer 110. In FIG. 17, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 17. The logical connections depicted in FIG. 17 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 17 illustrates remote application programs 185 as residing on memory device 181. It will be appreciated that the network connections shown are exemplary and other means of establishing a communications link between the computers may be used.

As the foregoing illustrates, the present invention is directed to a system and method for storing and retrieving XML data as a field of an instance of a user defined type within a database store. It is understood that changes may be made to the embodiments described above without departing from the broad inventive concepts thereof. For example, while an embodiment of the present invention has been described above as being implemented in Microsoft's SQL SERVER database management system, it is understood that the present invention may be embodied in any database management system that supports the creation of user defined types. Accordingly, it is understood that the present invention is not limited to the particular embodiments disclosed, but is intended to cover all modifications that are within the spirit and scope of the invention as defined by the appended claims.

1. In a system in which an object that is an instance of a user defined type can be persisted in a database store, wherein a definition of the user defined type is provided as a class in managed code and comprises one or more fields and behaviors, each field having a respective data type, a method comprising:
defining a class in managed code that represents an XML data type for a field of a user defined type;
defining a field within the managed code class definition of a user defined type as an instance of the managed code class that represents the XML data type; and
persisting an instance of the user defined type within the database store, whereby a field of the persisted instance can contain XML data.

2. The method recited in claim 1, wherein the managed code class that represents the XML data type comprises at least one constructor and at least one method that returns an object through which the XML data in the field of the persisted instance of the user defined type can be retrieved.

3. The method recited in claim 1, further comprising adding a method to the managed code class definition of the user defined type to implement behavior on the field of the user defined type that is defined as an instance of the managed code class that represents the XML data type.

4. The method recited in claim 1, further comprising the step of associating the field of an instance of the user defined type that contains XML data with an XML Schema that defines a content model for the XML data in the field.

5. The method recited in claim 4, wherein said associating step comprises annotating the managed code class definition of the user defined type with an attribute that identifies the XML Schema on a server that hosts the database store.

6. The method recited in claim 1, further comprising at least one of the steps of:
querying an instance of the user defined type persisted within the database store; and
modifying an instance of the user defined type persisted within the database store.

7. A system comprising:
a runtime that provides managed code execution, the runtime comprising:
a class in managed code that represents an XML data type; and
a class in managed code that defines a user defined type for storage of objects of that type within a database store, the class definition for the user defined type comprising one or more fields, each field having a respective data type and at least one of said fields being defined as an instance of the managed code class that represents the XML data type; and
a database store for storing an instance of the user defined type, whereby a field of the persisted instance can contain XML data.

8. The system recited in claim 7, wherein the managed code class that represents the XML data type comprises at least one constructor and at least one method that returns an object through which the XML data in the field of the persisted instance of the user defined type can be retrieved.

9. The system recited in claim 7, wherein the managed code class that defines the user defined type further comprises a method that implements behavior on the field of the instance of the user defined type that contains XML data.

10. The system recited in claim 7, wherein the managed code class that defines the user defined type further comprises an association between the field of an instance of the user defined type that contains XML data and an XML Schema that defines a content model for the XML data in the field.

11. The system recited in claim 10, wherein the association comprises an attribute applied to the field within the managed code class that defines the user defined type, the attribute identifying the XML Schema on a server that hosts the database store.

12. A computer readable medium having program code stored thereon for use in a system in which an object that is an instance of a user defined type can be persisted in a database store, said program code comprising:
a first class in managed code that represents an XML data type for a field of a user defined type;
a second class in managed code that defines a user defined type, the second class comprising one or more fields and behaviors, each field having a respective data type, at least one of the fields within the second class being defined as an instance of the first class,
said program code, when executed on a computer, enabling the computer to persist an instance of the user defined type within the database store, wherein said at least one field of the persisted instance contains XML data.

13. The computer readable medium recited in claim 1, wherein the first class comprises at least one constructor and at least one method that returns an object through which the XML data in the field of the persisted instance of the user defined type can be retrieved.

14. The computer readable medium recited in claim 12, wherein the second class further comprises a method that implements behavior on said at least one field of the user defined type that is defined as an instance of the first class.

15. The computer readable medium recited in claim 12, wherein said at least one field of an instance of the user defined type that contains XML data is associated with an XML Schema that defines a content model for the XML data in the field.

16. The computer readable medium recited in claim 15, wherein said at least one field is associated with said XML Schema by an annotation to the definition of said at least one field in the second class of an attribute that identifies the XML Schema on a server that hosts the database store.

17. The computer readable medium recited in claim 12, wherein said program code further enables the computer to:
query an instance of the user defined type persisted within the database store; and
modify an instance of the user defined type persisted within the database store.
